(19) United States
(12) Patent Application Publication
(10) Pub. No.: US 2009/0243269 A1
(43) Pub. Date: Oct. 1, 2009

(54) Airbag cover element

(75) Inventors: Uwe Braun, Muenchen (DE); Volker Hufnagel, Herrsching (DE)

Correspondence Address: COLLARD & ROE, P.C., 1077 NORTHERN BOULEVARD, ROSLYN, NY, 11576, US

(73) Assignee: Schreiner Group GMBH & Co. KG

(21) Appl. No.: 12/383,172

(22) Filed: Mar. 20, 2009

(30) Foreign Application Priority Data
Mar. 26, 2008 (DE) 10 2008 015 731.7

(51) Int. Cl. B60R 21/26

(52) U.S. Cl. 280/739

(57) ABSTRACT

The valve closure layer (6) comprises at least one, preferably a plurality of, gas throughflow opening(s) (4) surrounding the gas outflow opening (1) in an annular manner and offset relative to the gas outflow opening (1) without overlap, and said valve closure layer overlaps the gas outflow opening (1) without an opening. A greater airbag internal pressure presses the valve closure layer (6) more firmly against the external layer (2) and thus reduces the gas outflow through the gas outflow opening (1). Such an airbag cover element may be configured as an integral part of the airbag cover or as a separate functional part to be attached over an airbag cover opening (on the inside or outside of the airbag).

The present invention relates to airbag cover elements, in particular airbag cover elements which comprise an external layer with a gas outflow opening and a valve closure layer hindering a gas outflow through the gas outflow opening, depending on the airbag internal pressure, and arranged on the side of the external layer facing the airbag interior.

When designing systems for passive safety of vehicle passengers in mass-produced vehicles, there is the problem that these systems are not able to be tailored to a specific person, but instead have to be designed such that vehicle passengers of different physiques are to be protected equally against injuries. This represents a challenge, in particular with the design of airbags, as with the same boundary conditions people with a high body weight would sink substantially more deeply into an airbag than people with a low body weight. In addition to the body weight, naturally the kinetic energy of the vehicle passenger striking the airbag quite considerably depends on the negative acceleration of the vehicle. It is desirable to have a lower airbag internal pressure when a passenger strikes the airbag with less kinetic energy, whereas the pressure is generally even further reduced during the course of sinking into an airbag. Striking of an airbag by a passenger with high kinetic energy, however, is countered with a greater internal pressure with the same airbag thickness, it being intended to avoid too great a pressure drop during the outflow of gas when sinking into the airbag. In order to achieve a good protective effect which is as consistent as possible for passengers of different weights, with different degrees of negative acceleration, generally electromechanical sensor and valve systems which are developed at great cost are used, which control the airbag ignition performance and the gas outflow from the airbag. Such systems are generally very effective but expensive. Additionally, there are generally certain reservations against the sharp increase in complicated sensors for passive vehicle safety, as in principle electronic systems involve a risk of failure, which although generally low is still present, which increases with the increasing complexity.

An airbag cover element of the aforementioned type may assist in reducing the complexity of an airbag system and in reducing the cost involved with the technical implementation. In the German published patent application DE 102 23 189 A1, an airbag cover consisting of a plurality of fabric layers stitched together is shown, in which the gas outflow opening provided in an external cover layer is covered by a catch dome layer made of a fabric of predetermined gas permeability. The fabric of the catch dome layer is stitched to other layers of the airbag cover, so that below a threshold pressure it is spaced apart from the gas outflow opening. If the threshold pressure is exceeded, a tear seam tears and permits the catch dome layer in the region of the gas outflow opening to bear against the external cover layer such that the gas outflow is further hindered. Due to the requirement of tear seams to tear in a defined manner, the design of such an airbag cover is also not completely simple. Additionally, the required seam paths may make the manufacture difficult, stitching errors in particular being able to impair the operational reliability, and therefore costly precautions having to be taken, to eliminate said stitching errors as far as possible.

In view of the foregoing the present invention aims to simplify and make more flexible the manufacture of airbag covers while the operational reliability remains the same or increases.

For this aim an airbag cover element is provided with the valve closure layer comprising at least one, preferably a plurality, of gas throughflow opening(s) surrounding the gas outflow opening in an annular manner and offset relative to the gas outflow opening without overlap, and said valve closure layer overlapping the gas outflow opening without an opening. A greater airbag internal pressure presses the valve closure layer more firmly against the external layer and thus reduces the gas outflow through the gas outflow opening. Such an airbag cover element may be configured as an integral part of the airbag cover or as a separate functional part to be attached over an airbag cover opening (on the inside or outside of the airbag).

According to an embodiment of the invention, no tear seams are required to ensure the operation. Preferably, the valve closure layer and the external layer are bonded together, so that manufacture without stitching is possible. Depending on the materials selected, welding, stitching or a combination of different connecting techniques is also possible.

According to an embodiment of the invention, the valve closure layer does not have to be gas permeable, whereby the choice of materials may be made more flexible. In addition to fabrics which are preferably substantially or completely gas-tight, the valve closure layer may advantageously also consist of a plastics film, a rigid or elastic membrane or a composite material. In principle, a plurality of flat materials may be selected for the valve closure layer and the external layer. Each of the layers may also, in turn, be constructed from a plurality of layers.

According to an embodiment, the gas throughflow openings are implemented as (preferably oval or round) material recesses. In principle, however, it is also possible to design said material recesses in the form of slots or the like.

According to a further feature, an airbag cover element of the aforementioned type is provided, in which the valve closure layer is arranged as an intermediate layer between the external layer and an internal layer, the internal layer comprising an internal opening at least partially overlapping the gas outflow opening, preferably to a large extent or completely, and the valve closure layer comprises a gas throughflow opening respectively at least partially overlapping the gas outflow opening and the internal opening, depending on the airbag internal pressure, and tangentially displaceable, depending on the airbag internal pressure, relative to the gas outflow opening and/or to the internal opening.

If the airbag cover element bulges outwards due to the airbag internal pressure ratios, according to this feature of the invention a lateral displacement of the valve closure layer in the region of the gas throughflow opening relative to the external and internal layer is triggered, whereby the region of the overlap between the gas outflow opening and/or internal opening and the gas throughflow opening becomes smaller, so that only a smaller gas flow may escape from the airbag.

Preferably, the gas throughflow opening is designed as a material recess.

According to an embodiment of the invention, in this case, once again no tear seams are required in order to ensure the operation. Preferably, the valve closure layer and the external layer and/or internal layer are bonded together so that manufacture as a functional part is possible without stitching. Depending on the materials selected, welding is also possible in this case.

With regard to the choice of materials, the above also applies to the internal layer.

According to an embodiment, the displaceability of the gas throughflow opening may be achieved by the valve closure layer comprising a separating line partially surrounding the gas throughflow opening. In this case, the valve closure layer may be completely cut in two at the separating line, for example by the separating line being designed as a punched portion, slot or cut. According to an alternative embodiment, the separating line may be designed as a weakened line, so that a considerable displacement of the gas throughflow opening may only be initiated when a minimum tension in the valve closure layer, which occurs due to exceeding a specific airbag internal pressure, causes a tear along the weakened line.

According to an embodiment, the airbag cover element has a further valve closure layer arranged between the valve closure layer and the internal layer, the further valve closure layer comprising a gas throughflow opening respectively at least partially overlapping the gas outflow opening and the internal opening, depending on the airbag internal pressure, and tangentially displaceable relative to the gas throughflow opening of the other valve closure layer, depending on the airbag internal pressure, and relative to the gas outflow opening and/or to the internal opening. In principle, the further valve closure layer is substantially also designed in a similar manner to the valve closure layer, disclosed in connection with the above preferred embodiments.

According to a further feature, an airbag cover element of the aforementioned type is provided, in which the valve closure layer comprises a peripheral edge fixing, with which it is fixed to the external layer, preferably bonded, the valve closure layer being moreover free of connections, in particular seams, to the external layer and other layers (if present) of the airbag cover element inside the region surrounded by the edge fixing and comprises at least one gas throughflow opening inside the region surrounded by the edge fixing.

In principle, each embodiment, implementation or variant of the invention described and/or indicated within the context of the present application, may be particularly advantageous depending on the economic and technical requirements in each individual case. Provided that nothing contrary is set forth and/or provided that in principle it is able to be produced technically, individual features of the disclosed embodiments may be replaced or combined with one another and with measures known per se from the prior art.

Common to all embodiments, implementations or variants is that the entire airbag cover does not have to be designed with a plurality of layers, but the valve closure layer and internal layer (if present) only need to be formed locally, so that an airbag cover element is produced which is defined in situ. According to the invention, airbag cover elements also do not need to be made as an integral part of the airbag cover, but may also be produced as separate functional parts and then attached over simple openings in the airbag covers, for example by bonding, welding or stitching. It may be advantageous to provide a plurality of such airbag cover elements. On the other hand, an airbag cover element may also be stretched such that it extends over a large region of the airbag cover or over the entire airbag cover.

Hereinafter and with reference to the accompanying drawings, examples of preferred embodiments of the present invention are described in more detail. The drawings are in this case purely schematic and, for reasons of clarity, not views to scale. In particular, ratios of the relative dimensions may deviate from actual embodiments. Elements corresponding to one another are respectively provided in the individual figures, provided they are useful, with the same reference numerals.

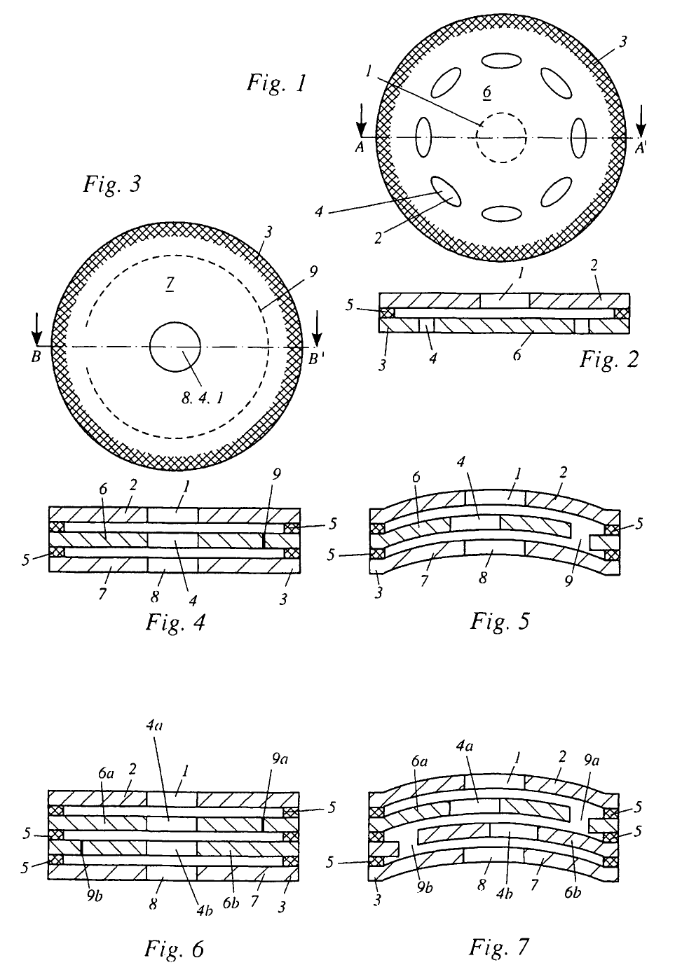

FIG. 1 shows an airbag cover element according to an embodiment of the present invention in plan view, viewed from the inside of the airbag.

FIG. 2 shows the airbag cover element of FIG. 1 in a sectional view along the cutting line A-A′ in FIG. 1, the arrows in FIG. 1 showing the viewing direction.

FIG. 3 shows an airbag cover element according to a further embodiment of the present invention in plan view, from below, i.e. according to requirements viewed from the inside of the airbag.

FIG. 4 shows the airbag cover element of FIG. 3 in a sectional view along the cutting line B-B′ in FIG. 3, the arrows in FIG. 3 indicating the viewing direction.

FIG. 5 shows the sectional view of FIG. 4 in a deformed state caused by the increasing internal pressure of the airbag.

FIG. 6 shows the sectional view of an airbag cover element according to the invention similar to FIG. 4, but in the embodiment shown two valve closure layers being provided superimposed over one another.

FIG. 7 shows the sectional view of FIG. 6 in a deformed state caused by the increasing internal pressure of the airbag.

The airbag cover element according to an embodiment of the invention shown in FIGS. 1 and 2 may be understood as a portion of an airbag cover or as a separate functional element which may be attached over an opening of an airbag cover (and correspondingly technically implemented), which limits the gas flow through the gas outflow opening 1 in the external layer 2 with increasing airbag internal pressure.

In the edge region 3 of the airbag cover element, the valve closure layer 6 is connected to the external layer 2 via an adhesive bond 5. Both layers 2, 6 may respectively be made from a plastics film composite, a single-layered film, a fabric which is as gas-tight as possible or the like. Within the surface surrounded by the edge region 3, the valve closure layer 6 is neither connected to the external layer 2 nor to a different layer of the airbag cover element.

The gas outflow opening 1 is completely covered by the valve closure layer 6. Gas may, however, flow out of the airbag, by passing between the valve closure layer 6 and external layer 2 through the gas throughflow openings 4 which are configured as oval material recesses in the valve closure layer 6, arranged in an annular manner about the gas outflow opening 1.

With increasing airbag internal pressure, the valve closure layer 6 is more firmly pressed against the external layer 2, which increases the seal of the gas outflow opening 1 and thus reduces the gas flow emerging from the airbag interior. In order to keep the gas outflow, which is pressure-dependent, through the gas outflow opening 1 in the desired range, a plurality of parameters are available to the designer for varying the design. In particular, the number and size of gas throughflow openings 4 as well as the distance thereof from the gas outflow opening 1 may be substantially freely selected. The exact design may thus be established by means of prototype testing with the desired airbag geometry or, however, with airbag cover elements tensioned via a suitable pressure cylinder.

Both the gas outflow opening 1 and also the gas throughflow openings 4 may advantageously be produced, for example by punching.

In FIGS. 3 to 5 an airbag cover element according to the invention is also shown, which limits the gas flow through the gas outflow opening 1 in the external layer 2 with increasing airbag internal pressure.

In this case, the gas outflow opening 1 is not covered by the valve closure layer 6 (or in alternative embodiments at least not completely), said valve closure layer being designed as an intermediate layer between the external layer 1 and internal layer 7. Instead, the gas outflow opening 1 in the external layer 2, the gas throughflow opening 4 in the valve closure layer 6 and an internal opening 8 in the internal layer 7 are arranged approximately aligned. In an alternative embodiment, they at least partially overlap. All openings 1, 4 and 8 may once again be produced by punching.

In the edge region 3 of the valve region, the valve closure layer 6 is respectively connected via an adhesive bond 5 to the external layer 2 and the internal layer 7. All layers 2, 6, 7 may respectively be made from a plastics film composite, a single-layered film, a fabric which is as gas-tight as possible, or the like. Inside the surface surrounded by the edge region 3, the valve closure layer 6 is neither connected to the external layer 2 nor to the internal layer 7.

The valve closure layer 6 has a separating line 9 in the form of an open ring, which surrounds the gas throughflow opening 4.

With increasing airbag internal pressure, the valve region increasingly bulges, as shown in FIG. 5. The region of the valve closure layer 6 which contains the gas throughflow opening 4, is only fixed on one side due to the separating line 9, and is uncoupled substantially from the remainder of the system, so that it is displaced relative to the external layer 2 and the internal layer 7, and with increased bulging of the external layer 2 and internal layer 7, the gas throughflow opening 4 in the valve closure layer 6 is increasingly less aligned with the gas outflow opening 1 in the external layer and the internal opening 8 in the internal layer 7. Instead, an increasingly large region of the gas outflow opening 1 is overlapped by the valve closure layer 6 and thus hinders the gas outflow.

The design may again result from testing. As design parameters, in addition to material properties, such as material thickness, expandability and elasticity, in particular the shape and size of the gas throughflow opening 4, the gas outflow opening 1 and the internal opening 8 are available. Moreover, the initial positions thereof may also be altered relative to one another, so that they only partially overlap.

FIG. 6 shows the sectional view of a further airbag cover element according to the invention similar to FIG. 4, however a further (subsequent second) valve closure layer 6b being provided between the (subsequent first) valve closure layer 6a and internal layer 7.

In this case, the gas outflow opening 1 is again not covered by the valve closure layers 6a, 6b (or in alternative embodiments at least not completely), said valve closure layers being designed as intermediate layers between the external layer 1 and the internal layer 7. Instead, the gas outflow opening 1 in the external layer 2, the gas throughflow openings 4a, 4b in the valve closure layers 6a, 6b and an internal opening 8 in the internal layer 7 are arranged approximately aligned. In an alternative embodiment, they overlap one another at least partially. All openings 1, 4a, 4b and 8 may again be produced by punching.

In the edge region 3 of the airbag cover element, the valve closure layers 6a, 6b are respectively connected via an adhesive bond 5 to one another, to the external layer 2 and to the internal layer 7. All layers 2, 6a, 6b, 7 may respectively be made from a plastics film composite, a single-layered film, a fabric which is as gas-tight as possible, or the like. Inside the surface surrounded by the edge region 3, the valve closure layers 6a, 6b are neither connected to the external layer 2 nor to the internal layer 7, nor to one another.

The valve closure layers 6a, 6b respectively have a separating line 9a, 9b in the form of an open ring (similar to FIG. 3) which surrounds the gas throughflow opening 4. The interruption of the separating line ring 9a in the first valve closure layer 6a in this case is provided on the opposing side (in the layer plane), from the interruption of the separating line ring 9b in the second valve closure layer 6b. In other words, the separating line 9a may be designed in a similar manner to the separating line 9 in FIG. 3, the separating line 9b corresponding to the separating line 9 in FIG. 3 being rotated by 180 degrees.

With increasing airbag internal pressure the airbag cover element increasingly bulges, as shown in FIG. 7. The region of the valve closure layers 6a, 6b which contains the respective gas throughflow opening 4a, 4b, is only fixed on one side due to the separating line 9a and/or 9b and substantially uncoupled from the remainder of the system, so that it is displaced relative to the external layer 2 and internal layer 7. Due to the configuration of the separating lines 9a, 9b which oppose one another (in the layer plane), the region of the first valve closure layer 6a is displaced with the corresponding gas throughflow opening 4a in the opposing direction, as is the region of the second valve closure layer 6b with the corresponding gas throughflow opening 4b.

With increased bulging of the external layer 2 and internal layer 7, the gas throughflow openings 4a, 4b in the valve closure layers 6a, 6b are increasingly less aligned with one another, with the gas outflow opening 1 in the external layer and the internal opening 8 in the internal layer 7. Instead, an even greater region of the gas outflow opening 1 is overlapped by the valve closure layers 6a, 6b and thus hinders the gas outflow.

The design may again result from testing. In addition to material properties such as material thickness, expandability and elasticity, therefore, in particular the shape and size of the gas throughflow openings 4a, 4b, the gas outflow opening 1 and the internal opening 8 are available as design parameters. Moreover, the initial positions thereof may also be altered relative to one another such that respectively they only partially overlap. Additionally, variations are possible in the arrangement of the separating lines 9a, 9b in the valve closure layers 6a, 6b relative to one another.

1. Airbag cover element, comprising an external layer (2) with a gas outflow opening (1) and a valve closure layer (6) hindering a gas outflow through the gas outflow opening (1), depending on the airbag internal pressure, and arranged on the side of the external layer (2) facing the airbag interior, wherein the valve closure layer (6) comprises at least one gas throughflow opening (4), offset relative to the gas outflow opening (1) without overlap, and said valve closure layer overlaps the gas outflow opening (1) without an opening.

2. Airbag cover element according to claim 1, the gas throughflow opening (4) being configured as a material recess.

3. Airbag cover element according to claim 1, the valve closure layer (6) comprising a plurality of gas throughflow openings (4) surrounding the gas outflow opening (1) in an annular manner.

4. Airbag cover element according to claim 1, the valve closure layer (6) and the external layer (2) being bonded together.

5. Airbag cover element according to claim 1, the valve closure layer (6) and the external layer (2) being welded together.

6. Airbag cover element according to claim 1, the valve closure layer (6) comprising a peripheral edge fixing (5) with which it is fixed to the external layer (2), the valve closure layer (6) being free of connections to the external layer (2) and other layers of the airbag cover element inside the region surrounded by the edge fixing (5), and the gas throughflow opening (4) being arranged inside the region surrounded by the edge fixing (5).

7. Airbag cover element, comprising an external layer (2) with a gas outflow opening (1) and a valve closure layer (6, 6a) hindering a gas outflow through the gas outflow opening (1), depending on the airbag internal pressure, and arranged on the side of the external layer (2) facing the airbag interior, wherein the valve closure layer (6, 6a) is arranged as an intermediate layer between the external layer (2) and an internal layer (7), the internal layer comprising an internal opening (8) at least partially overlapping the gas outflow opening (1), the valve closure layer (6, 6a) comprising a gas throughflow opening (4, 4a) respectively at least partially overlapping the gas outflow opening (1) and the internal opening (8), depending on the airbag internal pressure, and tangentially displaceable, depending on the airbag internal pressure, relative to the gas outflow opening (1) and/or to the internal opening (8).

8. Airbag cover element according to claim 7, the gas throughflow opening (4, 4a) being designed as a material recess.

9. Airbag cover element according to claim 7, the valve closure layer (6, 6a) comprising a separating line (9) partially surrounding the gas throughflow opening (4, 4a).

10. Airbag cover element according to claim 9, the valve closure layer (6) being completely cut in two at the separating line (9).

11. Airbag cover element according to claim 9, the separating line (9) being designed as a weakened line.

12. Airbag cover element according to claim 7, the valve closure layer (6, 6a) being bonded to the external layer (2) and/or the internal layer (7).

13. Airbag cover element according to claim 7, the valve closure layer (6, 6a) being welded to the external layer (2) and/or the internal layer (7).

14. Airbag cover element according to claim 7, the valve closure layer (6, 6a) comprising a peripheral edge fixing (5), with which it is fixed to the external layer (2) and/or internal layer (8),
the valve closure layer (6, 6a) being free of connections to the external layer (2), internal layer (7) and other layers of the airbag cover element inside the region surrounded by the edge fixing.

15. Airbag cover element according to claim 7 comprising a further valve closure layer (6b) arranged between the valve closure layer (6a) and internal layer (8), the further valve closure layer (6b) comprising a gas throughflow opening (4b) respectively at least partially overlapping the gas outflow opening (1) and the internal opening (8), depending on the airbag internal pressure, and tangentially displaceable relative to the gas throughflow opening (4a) of the other valve closure layer (6a), depending on the airbag internal pressure, and relative to the gas outflow opening (1) and/or to the internal opening.

16. Airbag cover element comprising an external layer (2) with a gas outflow opening (1) and a valve closure layer (6, 6a) hindering a gas outflow through the gas outflow opening (1), depending on the airbag internal pressure, and arranged on the side of the external layer (2) facing the airbag interior, characterized in that the valve closure layer (6, 6a) comprises a peripheral edge fixing (5), with which it is fixed to the external layer (2), is free of connections to the external layer (2) and other layers of the airbag cover element inside the region surrounded by the edge fixing (5), and comprises at least one gas throughflow opening (4, 4a) inside the region surrounded by the edge fixing (5).
